(19) United States
(12) Patent Application Publication
(10) Pub. No.: US 2007/0269332 A1
(43) Pub. Date: Nov. 22, 2007

(54) Method for Producing Composite Soft Magnetic Material Having High Strength and High Specific Resistance

(75) Inventors: Masahisa Miyahara, Niigata-shi (JP); Koichiro Morimoto, Niigata-shi (JP)

Correspondence Address: DARBY & DARBY P.C., P.O. BOX 770, Church Street Station, New York, NY, 10008-0770, US

(73) Assignee: MITSUBISHI MATERALS PMG CORORATION, NIIGATA-SHI NIIGATA JAPAN (JP)

(21) Appl. No.: 10/595,595

(22) PCT Filed: Oct. 28, 2004
(86) PCT No.: PCT/JP04/15983

§ 371 Date: Apr. 19, 2007

(30) Foreign Application Priority Data
Oct. 30, 2003 (JP) 2003-370335

(51) Int. Cl. B22F 3/16; H01F 1/26; H01F 1/33

(52) U.S. Cl. 419/23; 252/62.53

(57) ABSTRACT

The present invention relates to composite soft magnetic materials having high strength and high specific resistance and a method of producing such materials by: heating mixture powder having a composition containing 0.05-1 wt % of polyimide resin powder having an average particle diameter of 1 to 100 μm, 0.002-0.1 wt % of fine amide-based wax powder having an average particle diameter of 1 to 20 μm, and the balance composed of insulating film-coated soft magnetic powder obtained by forming an insulating film on the surface of soft magnetic powder, at a temperature of 60 to 110° C.; filling the heated mixture powder in a mold which is heated at a temperature of 100 to 150° C.; compacting the heated mixture powder at a molding pressure of 700 to 1200 MPa to obtain a compact; and curing the obtained compact at a temperature of 225 to 300 ° C.

### CROSS-REFERENCE TO PRIOR RELATED APPLICATIONS

This application is a U.S. national phase application under 35 U.S.C. §371 of International Patent Application No. PCT/JP2004/015983, filed Oct. 28, 2004, and claims the benefit of Japanese Application No. 2003-370335, filed Oct. 30, 2003, both of which are incorporated by reference herein. The International Application was published in Japanese on May 12, 2005 as International Publication No. WO 2005/043559 under PCT Article 21 (2).

### TECHNICAL FIELD

The present invention relates to: a method of producing a composite soft magnetic material having high strength and high specific resistance; and a composite soft magnetic material having high strength and high specific resistance, which is produced by the method. The method of producing the composite soft magnetic material may be used for producing an injector part, an ignition part, an electronic valve core, and a motor core.

### BACKGROUND ART

Among the materials generally known as soft magnetic powder are iron powder, Fe—Si iron-based soft magnetic alloy powder, Fe—Al iron-based soft magnetic alloy powder, Fe—Si—Al iron-based soft magnetic alloy powder, Fe—Cr iron-based soft magnetic alloy powder, Ni-based soft magnetic alloy powder, and Fe—Co iron-based soft magnetic alloy powder. The iron powder includes pure iron powder, the Fe—Si iron-based soft magnetic alloy powder includes Fe—Si iron-based soft magnetic alloy powder containing 0.1-10 wt % of Si and the balance composed of Fe and necessary impurities, additives, or dopants (for example, ferrosilicon powder containing 1-12 % of Si and the balance composed of Fe and necessary impurities, and more particularly, Fe-3% Si powder), the Fe—Al iron-based soft magnetic alloy powder includes Fe—Al iron-based soft magnetic alloy powder containing 0.05-10 wt % of Al and the balance composed of Fe and necessary impurities (for example, Al perm powder having a composition of Fe-15% Al), the Fe—Si—Al iron-based soft magnetic alloy powder includes Fe—Si—Al iron-based soft magnetic alloy powder containing 0.1-10 wt % of Si, 0.05-10 wt % of Al and the balance composed of Fe and necessary impurities (for example, Sendust powder having a composition of Fe-9% Si-5% Al), the Fe—Cr iron-based soft magnetic alloy powder includes Fe—Cr iron-based soft magnetic alloy powder containing 1-20 % of Cr, and if necessary, either or both of 5 % or less of Al and 5% or less of Si, and the balance composed of Fe and necessary impurities, the Ni-based soft magnetic alloy powder includes Ni-based soft magnetic alloy powder containing 35-85% of Ni, and if necessary, one or two of 5% or less of Mo, 5% or less of Cu, 2% or less of Cr, and 0.5% or less of Mn, and the balance composed of Fe and necessary impurities (for example, Fe-79% Ni powder), and the Fe—Co iron-based soft magnetic alloy powder includes Fe—Co iron-based soft magnetic alloy powder containing 10-60 % of Co, and if necessary, 0.1-3% of V, and the balance composed of Fe and necessary impurities. (“%” means “wt %” for above.)

An insulating film is formed on such soft magnetic powder to produce insulating film-coated soft magnetic powder and the insulating film-coated soft magnetic powder is hardened with resin to produce a composite soft magnetic material. As the insulating film-coated soft magnetic powder, there are known: oxide film-coated soft magnetic powder formed by performing high-temperature oxidation treatment on the soft magnetic powder to form an oxide film on the surface thereof; phosphate film-coated soft magnetic powder formed by performing phosphate treatment on the soft magnetic material to form a phosphate film on the surface thereof; and hydroxylated film-coated soft magnetic powder formed by performing stream treatment on the soft magnetic powder to form an insulating hydroxylated film on the surface thereof. Among these insulating film-coated soft magnetic powders, phosphate film-coated soft magnetic powder obtained by forming a phosphate film on the surface of pure iron powder is generally used.

As a method of hardening the insulating film-coated soft magnetic powder with the resin to produce a composite soft magnetic material, there is a method of placing mixture resin powder obtained by mixing 0.2-10 wt % of polyphenylenesulfide resin powder which is a thermoplastic compound having a particle diameter of 1 to 100μm and 0.05-1 wt % of stearic acid powder having a particle diameter of 1 to 100μm to the insulating film-coated soft magnetic powder in a mold which is heated to a temperature of 50 to 90° C., compression-molding the mixture resin powder to produce a compact, curing the obtained compact at a temperature of 200 to 270° C. in a nitrogen atmosphere to remove the stearic acid, and further heating the compact at a temperature of 285 to 310° C. in a nitrogen atmosphere (see PCT Japanese Translation Patent Publication No. 2001-504283).

The method of hardening the insulating film-coated soft magnetic powder with the resin to produce the composite soft magnetic material can provide an excellent composite soft magnetic material, because the polyphenylenesulfide resin has a high melting point and excellent heat resistance and has good heat resistance and insulation property even at high temperatures. However, this method suffers from inferior moldability, because the polyphenylenesulfide resin powder has a melting point of at least 200° C. To this end, there is suggested a method of adding 1-99% of polyamide resin powder to polyphenylenesulfide resin powder to produce mixture resin powder, compression-molding mixture powder obtained by adding 0.1-3 wt % of the mixture resin powder to insulating film-coated soft magnetic powder to produce a compact, and curing the obtained compact at a temperature of 250 to 450° C. in a nitrogen atmosphere to produce a composite soft magnetic material (see Japanese Unexamined Patent Application Publication No. 2003-183702).

### DISCLOSURE OF THE INVENTION

### Problems to be Solved by the Invention

However, the composite soft magnetic material produced by using mixture powder obtained by adding insulating film-coated soft magnetic powder to mixture resin powder composed of polyphenylenesulfide resin powder and the stearic acid or mixture resin powder composed of polyphenylenesulfide resin powder and polyamide resin powder need be cured at as high a temperature as possible, because sufficient transverse rupture strength cannot be obtained when the composite soft magnetic material is cured at a low temperature. However, when the composite soft magnetic material is cured at the high temperature in order to improve the transverse rupture strength, the specific resistance of the composite soft magnetic material is reduced.

### Means for Solving the Problems

Accordingly, the present inventors researched into a method of producing a composite soft magnetic material having high strength and high specific resistance and obtained the result that mixture powder having a composition containing 0.05-1 wt % of polyimide resin powder having an average particle diameter of 1 to 100 μm, 0.002-0.1 wt % of fine amide-based wax powder having an average particle diameter of 1 to 20 μm, and the balance composed of insulating film-coated soft magnetic powder obtained by forming an insulating film on the surface of soft magnetic powder has good moldability, and a composite soft magnetic material obtained by heating the mixture powder at a temperature of 60 to 110° C., filling the heated mixture powder in a mold which is heated at a temperature of 100 to 150° C., compacting the heated mixture powder at a molding pressure of 700 to 1200 MPa to obtain a compact, and curing the obtained compact at a temperature of 225 to 300° C. has higher strength and higher specific resistance, in comparison with conventional composite soft magnetic materials.

According to one aspect of the present invention, there is provided a method of producing a composite soft magnetic material having high strength and high specific resistance, including: heating mixture powder having a composition containing 0.05-1 wt % of polyimide resin powder having an average particle diameter of 1 to 100μm, 0.002-0.1 wt % of fine amide-based wax powder having an average particle diameter of 1 to 20 μm, and the balance composed of insulating film-coated soft magnetic powder obtained by forming an insulating film on the surface of soft magnetic powder, at a temperature of 60 to 110° C; filling the heated mixture powder in a mold which is heated at a temperature of 100 to 150° C.; compacting the heated mixture powder at a molding pressure of 700 to 1200 MPa to obtain a compact; and curing the obtained compact at a temperature of 225 to 300° C.

As the insulating film-coated soft magnetic powder obtained by forming an insulating film on the surface of soft magnetic powder, phosphate film-coated pure iron powder obtained by forming a phosphate film on the surface of pure iron powder may be used.

Thus, according to another aspect of the present invention, there is provided a method of producing a composite soft magnetic material having high strength and high specific resistance, including: heating mixture powder having a composition containing 0.05-1 wt % of polyimide resin powder having an average particle diameter of 1 to 100 μm, 0.002-0.1 wt % of fine amide-based wax powder having an average particle diameter of 1 to 20 μm, and the balance composed of phosphate film-coated iron powder obtained by forming a phosphate film on the surface of pure iron powder, at a temperature of 60 to 110° C; filling the heated mixture powder in a mold which is heated at a temperature of 100 to 150° C.; compacting the heated mixture powder at a molding pressure of 700 to 1200 MPa to obtain a compact; and curing the obtained compact at a temperature of 225 to 300° C.

### Effect of the Invention

The present invention enables one to produce a composite soft magnetic material having higher strength and higher specific resistance, in comparison with conventional composite soft magnetic materials.

As the polyimide resin powder contained in the mixture powder used for the method of producing the composite soft magnetic material according to the present invention, wholly aromatic polyimide resin powder, bismaleide-based polyimide resin powder, or additive polyimide resin powder may be used and the average particle diameter thereof is preferably in a range of 1 to 100 μm (preferably 10 to 80 μm, and more preferably 10 to 50 μm). This is because it is difficult to produce polyimide resin powder having an average particle diameter of 1 μm or less and it is impossible to obtain sufficient strength and high specific resistance when the polyimide resin powder having an average particle diameter of 100 μm or more is used. In addition, the amount of the polyimide resin powder contained in the mixture powder is preferably in a range of 0.05 to 1 wt % (more preferably 0.1 to 0.5 wt %) . This is because sufficient specific resistance cannot be ensured when the amount of the polyimide resin powder contained in the mixture powder is less than 0.05 wt % and density, flux density, and magnetic permeability are reduced when the amount of the polyimide resin powder is greater than 1 wt %.

In addition to the polyimide resin powder, 0.002-0.1 wt % (preferably, 0.004-0.05 wt %) of fine amide-based wax powder having an average particle diameter of 1 to 20 μm (preferably, 1 to 10 μm) need be added to the mixture powder as lubricant. As the amide-based wax, simple substance of ethylenebisstearoamide, ethylenebislauramide, or methylenebisstearoid, or a mixture thereof may be used.

By adding the amide-based wax powder together with the polyimide resin powder, filling property of the polyimide resin is improved to suppress generation of a large triple point and crescent tear due to extrusion of resin to the triple point is prevented from occurring in the powder grain boundary, thereby increasing the density of the compact. However, when the amount of the amide-based wax powder contained in the mixture powder is less than 0.002 wt %, sufficient flow property cannot be ensured, and when the amount of the amide-based wax powder contained in the mixture powder is greater than 0.1 wt %, the strength of the composite soft magnetic material is reduced. Accordingly, the amount of the amide-based wax powder contained in the mixture powder is chosen to be 0.002 to 0.1 wt %.

The average particle diameter of the amide-based wax powder added to the mixture powder is preferably in a range of 1 to 20 μm. This is because it is difficult to produce amide-based wax powder having an average particle diameter of 1 μm or less and because the amount of the added material necessary for ensuring the flow property increases too much to achieve sufficient strength when amide-based powder having an average particle diameter of 20 μm or more is used.

The mixture powder having such a composition is heated at a temperature of 60 to 110° C., and filled and compression-molded in a mold which is heated at a temperature of 100 to 150° C. The reason why the mold is heated at the temperature of 100 to 150° C. is because, when colloidal lubricant agent is coated on a wall surface of the mold, moisture contained in the lubricant agent is evaporated and the solid lubricant agent is attached to the wall surface of the mold. Accordingly, the heating temperature of the mold need be 100° C. or more, but need not be 150° C. or more. When the heating temperature of the mixture powder filled in the heated mold is less than 60° C., the density of the compact does not increase, and when the heating temperature of the mixture powder is greater than 110° C., the flow property is reduced. Accordingly, the mixture powder filled in the mold is heated at the temperature of 60 to 110° C.

The reason why the mixture powder filled in the mold is compression-molded at the pressure of 700 to 1200 MPa is because, when the compression molding pressure is less than 700 MPa, sufficient density cannot be obtained, and when the compression molding pressure is greater than 1200 MPa, the specific resistance is reduced. The compact obtained by the compression molding is cured at a temperature of 225 to 300° C. for 30 to 60 minutes. By curing at the above-described temperature, a composite soft magnetic material having high strength and high specific resistance is obtained. In addition, by curing at the above-described temperature, distortion of the soft magnetic powder is removed and soft magnetic property is restored. The reason why the curing temperature is limited to 225 to 300° C. is because the resin is insufficiently hardened when the curing temperature is less than 225° C. and the strength and the specific resistance are reduced due to the decomposition of the resin when the curing temperature is greater than 300° C.

According to this method of producing the composite soft magnetic material using the polyimide resin powder, it is possible to produce a composite soft magnetic material having higher strength and higher specific resistance, in comparison with conventional composite soft magnetic materials produced by using polyphenylenesulfide resin powder. This is because polyphenylenesulfide resin has inferior distortion property and thus damages the insulating film of the insulating film-coated soft magnetic powder at the time of compression-molding at 700 to 1200 MPa, leading to reduced specific resistance. Meanwhile, when the ratio of the polyamide resin is large, the polyamide resin is too soft and thus crescent tear of the insulating film generated between grains of the insulating film-coated soft magnetic powder occurs, thereby reducing the specific resistance.

### BEST MODE FOR CARRYING OUT THE INVENTION

### Embodiment

As a raw material, phosphate film-coated iron powder having an average particle diameter of 80 μm, which is obtained by performing phosphate treatment on pure iron powder to form a phosphate film on the surface thereof, was prepared and additive polyimide resin powder and ethylenebisstearoamide powder having average particle diameters shown in Table 1 were prepared. By adding and mixing the additive polyimide resin powder and the ethylenebisstearoamide powder to the phosphate film-coated iron powder with ratios shown in Table 1 in ambient atmosphere, mixture powders A to R of compositions shown in Table 1 were produced.

TABLE 1

| | | Composition (wt %) | | | | |
|---|---|---|---|---|---|---|
| | | Additive | | Ethylenebis- | | |
| | | polyimide | | stearoamide | | |
| | | resin powder | | powder | | |
| | | Average | | Average | | |
| | | particle | | particle | | Phosphate |
| | | diameter | | diameter | | film-coated |
| Type | | (μm) | | (μm) | | iron powder |
| Mixture | A | 40 | 0.2 | 5 | 0.01 | Balance |
| powder | B | 40 | 0.05 | 5 | 0.01 | Balance |
| | C | 40 | 0.1 | 5 | 0.01 | Balance |
| | D | 40 | 0.4 | 5 | 0.01 | Balance |
| | E | 40 | 0.6 | 5 | 0.01 | Balance |
| | F | 40 | 0.8 | 5 | 0.01 | Balance |
| | G | 20 | 0.2 | 10 | 0.004 | Balance |
| | H | 20 | 0.2 | 10 | 0.008 | Balance |
| | I | 20 | 0.25 | 10 | 0.02 | Balance |
| | J | 20 | 0.25 | 10 | 0.04 | Balance |
| | K | 80 | 0.25 | 10 | 0.06 | Balance |
| | L | 80 | 0.25 | 10 | 0.09 | Balance |
| | M | 40 | 1.1* | 5 | 0.01 | Balance |
| | N | 80 | 0.04* | 10 | 0.01 | Balance |
| | O | 105* | 0.1 | 5 | 0.01 | Balance |
| | P | 40 | 0.2 | 10 | 0.12* | Balance |
| | Q | 40 | 0.2 | 10 | 0.0015* | Balance |
| | R | 40 | 0.2 | 22* | 0.01 | Balance |

Symbol * shows a value out of a range of the present invention.

The mixture powders A to R were heated at temperatures shown in Tables 2 and 3. In addition, an aqueous solution including 1% of sodium benzoate and 1% of dipotassium hydrogen phosphate was sprayed and dried on a wall surface of a mold which was heated at temperatures shown in Tables 2 and 3, the heated mixture powders A to R were filled in the mold which was heated at temperatures shown in Tables 2 and 3 and compression-molded with pressures shown in Tables 2 and 3 to produce a compact, and the compact was heated for a time shown in Tables 2 and 3 at the temperature shown in Table 2 and 3 in ambient atmosphere, the various combinations of conditions represented by Present methods 1 to 12 and Comparative methods 1 to 13 in the Tables. Accordingly composite soft magnetic samples having a size of 5 mm×10 mm×60 mm were produced.

The transverse rupture strength, the density, the specific resistance, and the flux density of the composite soft magnetic samples were measured at room temperature and the measured results are shown in Tables 2 and 3.

### CONVENTIONAL EXAMPLE

Mixture powder obtained by adding and mixing 1 wt % of polyphenylenesulfide resin powder having an average particle diameter of 30 μm and 0.2 wt % of stearic acid powder having an average particle diameter of 30 μm to the insulating film-coated iron powder prepared in the embodiment above was filled in a mold which was heated at a temperature of 70° C. and was compression-molded to produce a compact, the obtained compact was cured at a temperature of 230° C. in a nitrogen atmosphere to remove stearic acid, and the compact was heated at a temperature of 300° C. in a nitrogen atmosphere, giving Conventional method 1 in the Tables.

In addition, mixture resin powder was produced by mixing 50 wt % of polyphenylenesulfide resin powder having an average particle diameter of 18 μm and 50 wt % of polyamide resin powder, 1.5 wt % of this mixture resin powder was mixed with the phosphate film-coated iron powder prepared in the embodiment above to produce mixture powder, the obtained mixture powder was compression-molded to produce a compact, and the obtained compact was cured at a temperature of 300° C. in a nitrogen atmosphere to produce a composite soft magnetic sample, giving Conventional method 2 in the Tables.

The transverse rupture strength, the density, the specific resistance, and the flux density of the composite soft magnetic samples obtained by Conventional methods 1 and 2 were measured at room temperature and the measured results are shown in Tables 2 and 3.

TABLE 2

| | | | Production condition | | | | | | | | |
|---|---|---|---|---|---|---|---|---|---|---|---|
| | | | Heating | Heating | | | | Property of soft magnetic sample | | | |
| | | | temperature | temperature | Compression | | | Transverse | | Specific | Flux |
| | | Mixture | of mixture | of | molding | Curing | Curing | rupture | | resistance | density |
| | | powder of | powder | mold | pressure | temperature | time | strength | Density | 10-4 | B_{10000 A/m} |
| Type | | Table 1 | (° C.) | (° C.) | (MPa) | (° C.) | (minute) | (MPa) | (Kg/m³) | (Ωm) | (T) |
| Present | 1 | A | 90 | 120 | 800 | 250 | 30 | 140 | 7.5 | 3.6 | 1.58 |
| method | 2 | B | 60 | 120 | 800 | | | 132 | 7.55 | 1.1 | 1.60 |
| | 3 | C | 80 | 120 | 800 | | | 140 | 7.53 | 2.7 | 1.59 |
| | 4 | D | 100 | 120 | 800 | | | 125 | 7.40 | 5.3 | 1.53 |
| | 5 | E | 110 | 120 | 800 | | | 125 | 7.33 | 8.1 | 1.50 |
| | 6 | F | 100 | 100 | 800 | | | 118 | 7.25 | 12 | 1.46 |
| | 7 | G | 100 | 130 | 800 | | | 135 | 7.61 | 3.4 | 1.56 |
| | 8 | H | 100 | 150 | 800 | | | 130 | 7.52 | 2.9 | 1.57 |
| | 9 | I | 100 | 120 | 1200 | | | 146 | 7.59 | 1.8 | 1.61 |
| | 10 | J | 100 | 120 | 1000 | | | 142 | 7.56 | 2.2 | 1.60 |
| | 11 | K | 100 | 120 | 770 | | | 130 | 7.44 | 3.8 | 1.55 |
| | 12 | L | 100 | 120 | 730 | | | 127 | 7.40 | 4.0 | 1.52 |
| | 1 | M | 100 | 120 | 800 | | | 82 | 7.09 | 52 | 1.35 |
| | 2 | N | 100 | 120 | 800 | | | 118 | 7.53 | 0.58 | 1.57 |

TABLE 3

| | | | Production condition | | | | | | | | |
|---|---|---|---|---|---|---|---|---|---|---|---|
| | | | Heating | Heating | | | | Property of soft magnetic sample | | | |
| | | | temperature of | temperature | Compression | | | Transverse | | Specific | Flux |
| | | Mixture | mixture | of | molding | Curing | Curing | rupture | | resistance | density |
| | | powder of | powder | mold | pressure | temperature | time | strength | Density | ×10⁻⁴ | B_{10000 A/m} |
| Type | | Table 1 | (° C.) | (° C.) | (MPa) | (° C.) | (minute) | (MPa) | (Kg/m³) | (Ωm) | (T) |
| Comparative | 3 | O | 100 | 120 | 800 | 250 | 30 | 97 | 7.50 | 0.65 | 1.58 |
| method | 4 | P | 100 | 120 | 800 | 250 | | 63 | 7.41 | 4.2 | 1.53 |
| | 5 | Q | 100 | 120 | 800 | 250 | | 110 | 7.48 | 0.92 | 1.56 |
| | 6 | R | 100 | 120 | 800 | 250 | | 92 | 7.47 | 0.88 | 1.55 |
| | 7 | A | 115* | 120 | 800 | 250 | | 85 | 7.38 | 0.78 | 1.52 |
| | 8 | A | 55* | 120 | 800 | 250 | | 98 | 7.40 | 1.0 | 1.51 |
| | 9 | A | 100 | 160* | 800 | 250 | | 111 | 7.50 | 0.61 | 1.57 |
| | 10 | A | 100 | 90* | 800 | 250 | | 87 | 7.38 | 2.1 | 1.51 |
| | 11 | A | 100 | 120 | 1300* | 250 | | 132 | 7.63 | 0.72 | 1.63 |
| | 12 | A | 100 | 120 | 650 | 250 | | 80 | 7.36 | 4.2 | 1.51 |
| | 13 | A | 10 | 120 | 800 | 320* | | 75 | 7.50 | 0.65 | 1.58 |
| | 14 | A | 100 | 120 | 800 | 320* | | 83 | 7.50 | 4.2 | 1.57 |

| | | | | | | |
|---|---|---|---|---|---|---|
| Conventional | 1 | — | 120 | 7.03 | 3.8 | 1.31 |
| method | 2 | — | 115 | 6.92 | 8.5 | 1.25 |

Symbol * shows a value out of a range of the present invention.

From the results shown in Tables 2 and 3, it can be seen that the soft magnetic samples produced by Present methods 1 to 12 have superior soft magnetic properties, compared with the soft magnetic samples produced by Conventional methods 1 and 2. In addition, the soft magnetic samples produced by Comparative methods 1 to 14 performed under conditions different from those of the present invention have partially inferior properties.

1. A method of producing a composite soft magnetic material having high strength and high specific resistance, the method comprising the steps of:
heating at a temperature of 60 to 110° C.-mixture powder comprising
0.05 to 1 wt % of polyimide resin powder having an average particle diameter of 1 to 100 μm,
0.002 to 1 wt % of fine amide-based wax powder having an average particle diameter of 1 to 20 μm, and
the balance composed of insulating film-coated soft magnetic powder obtained by forming an insulating film on the surface of soft magnetic powder;
filling the heated mixture powder in a mold which is heated at a temperature of 100 to 150° C.;
compression-molding the heated mixture powder at a molding pressure of 700 to 1200 MPa to obtain a compact; and
curing the obtained compact at a temperature of 225 to 300° C.

2. The method of claim 1, wherein the insulating film-coated soft magnetic powder is phosphate film-coated iron powder obtained by forming a phosphate film on the surface of pure iron powder.

3. A composite soft magnetic material having high strength and high specific resistance, produced by the method of claim.

4. A composite soft magnetic material having high strength and high specific resistance, produced by the method of claim 2.

5. The method of claim 1, wherein the polyimide resin powder comprises wholly aromatic polyimide resin powder or bismaleide-based polyimide resin powder or both.

6. A composite soft magnetic material having high strength and high specific resistance, produced by the method of claim 5.

7. The method of claim 1, wherein the average particle diameter of the polyimide resin powder is 10 to 80 μm.

8. A composite soft magnetic material having high strength and high specific resistance, produced by the method of claim 7.

9. The method of claim 1, wherein the average particle diameter of the polyimide resin powder is 10 to 50 μm.

10. A composite soft magnetic material having high strength and high specific resistance, produced by the method of claim 9.

11. The method of claim 1, wherein the amount of the polyimide resin powder in the mixture powder is 0.1 to 0.5 wt %.

12. A composite soft magnetic material having high strength and high specific resistance, produced by the method of claim 11.

13. The method of claim 1, wherein the amount of the fine amide-based wax powder in the mixture powder is 0.004 to 0.05 wt %.

14. A composite soft magnetic material having high strength and high specific resistance, produced by the method of claim 13.

15. The method of claim 1, wherein the average particle diameter of the fine amide-based wax powder is 1 to 10 μm.

16. A composite soft magnetic material having high strength and high specific resistance, produced by the method of claim 15.

17. The method of claim 1, wherein the fine amide-based wax powder is ethylenebisstearoamide, ethylenebislauramide, or methylenebisstearoid, or a mixture thereof.

18. A composite soft magnetic material having high strength and high specific resistance, produced by the method of claim 17.

19. The method of claim 1, wherein the compact is cured for 30 to 60 minutes.

20. A composite soft magnetic material having high strength and high specific resistance, produced by the method of claim 19.
